(19) United States
(12) Patent Application Publication
(10) Pub. No.: US 2017/0192485 A1
(43) Pub. Date: Jul. 6, 2017

(54) PROVIDING A POWER OPTIMIZED DESIGN FOR A DEVICE

(71) Applicant: International Business Machines Corporation, Armonk, NY (US)

(72) Inventors: Nagashyamala R. Dhanwada, Fishkill, NY (US); Viresh Paruthi, Austin, TX (US)

(21) Appl. No.: 14/987,160

(22) Filed: Jan. 4, 2016

(51) Int. Cl. G06F 1/32; G06F 9/48; G06F 1/28

(52) U.S. Cl. CPC G06F 1/3228; G06F 1/28; G06F 9/4881

(57) ABSTRACT

Embodiments include method, systems and computer program products for providing a power optimized design for a device. Aspects include identifying a region of the device. Aspects further include identifying an activity group corresponding to the region. Based on the activity group, aspects also include initializing a workload corresponding to the activity group with at least one parameter. Based on the workload, aspects include obtaining a power consumption value corresponding to the workload of the region. Aspects further include identifying the at least one parameter corresponding to the power consumption value. Aspects further include modifying the at least one parameter to provide at least one modified parameter. Based on the modified power consumption value and the power consumption value, aspects include analyzing the modified power consumption value and the power consumption value and determining the power sensitivity characteristic of the region of the device.

### BACKGROUND

The present disclosure relates to power optimization, and more specifically, to methods, systems and computer program products for providing a power optimized design for a device.

Electronic products are often designed to minimize power consumption. In general, by minimizing power consumption, thermal consumption, cost, and reliability can be positively affected.

Electronic products or devices can be logically divided into various regions that perform various tasks and provide various functions. In certain applications, various regions can have different power consumption characteristics.

Regions of an electronic device or product can be optimized for power consumption using either automated or manual design techniques. However, regions eligible or targeted for power consumption optimization may not be readily identifiable.

### SUMMARY

In accordance with an embodiment, a computer-implemented method for providing a power optimized design for a device is provided. The method includes identifying a region of the device. The method further includes identifying an activity group corresponding to the region. Based on the activity group, the method also includes initializing a workload corresponding to the activity group with at least one parameter. Based on the workload, the method includes obtaining a power consumption value corresponding to the workload of the region. The method further includes identifying the at least one parameter corresponding to the power consumption value. The method further includes modifying the at least one parameter to provide at least one modified parameter. Based on the modified parameter, the method includes initializing the workload corresponding to the activity group with the at least one modified parameter via the processor. Based on the workload with the at least one modified parameter, the method further includes obtaining a modified power consumption value corresponding to the workload of the region with the at least one modified parameter. Based on the modified power consumption value and the power consumption value, the method includes analyzing the modified power consumption value and the power consumption value and determining the power sensitivity characteristic of the region of the device.

In accordance with a further embodiment, a computer program product for providing a power optimized design for a device includes a non-transitory storage medium readable by a processing circuit and storing instructions for execution by the processing circuit for performing a method. The method includes identifying a region of the device. The method further includes identifying an activity group corresponding to the region. Based on the activity group, the method also includes initializing a workload corresponding to the activity group with at least one parameter. Based on the workload, the method includes obtaining a power consumption value corresponding to the workload of the region. The method further includes identifying the at least one parameter corresponding to the power consumption value. The method further includes modifying the at least one parameter to provide at least one modified parameter. Based on the modified parameter, the method includes initializing the workload corresponding to the activity group with the at least one modified parameter via the processor. Based on the workload with the at least one modified parameter, the method further includes obtaining a modified power consumption value corresponding to the workload of the region with the at least one modified parameter. Based on the modified power consumption value and the power consumption value, the method includes analyzing the modified power consumption value and the power consumption value and determining the power sensitivity characteristic of the region of the device.

In accordance with another embodiment, a power optimization system for providing a power optimized design for a device is provided. The processor is configured to identify a region of the device. The processor is configured to identify an activity group corresponding to the region. Based on the activity group, the processor is configured to initialize a workload corresponding to the activity group with at least one parameter. Based on the workload, the processor is configured to obtain a power consumption value corresponding to the workload of the region. The processor is configured to identify the at least one parameter corresponding to the power consumption value. The processor is configured to modify the at least one parameter to provide at least one modified parameter. Based on the modified parameter, the processor is configured to initialize the workload corresponding to the activity group with the at least one modified parameter via the processor. Based on the workload with the at least one modified parameter, the processor is configured to include obtaining a modified power consumption value corresponding to the workload of the region with the at least one modified parameter. Based on the modified power consumption value and the power consumption value, the processor is configured to analyze the modified power consumption value and the power consumption value and determining the power sensitivity characteristic of the region of the device.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a block diagram illustrating one example of a processing system for practice of the teachings herein;

FIG. 2 is a flow diagram of a method for providing a power optimized design for a device in accordance with an exemplary embodiment; and

FIG. 3 is a flow diagram of a method for providing a power optimized design for a device in accordance with an exemplary embodiment.

### DETAILED DESCRIPTION

In accordance with exemplary embodiments of the disclosure, methods, systems and computer program products for providing a power optimized design for a device is provided. In exemplary embodiments, the power optimization system is configured to identify a region of the device. The processor is configured to identify an activity group corresponding to the region. Based on the activity group, the power optimization system is configured to initialize a workload corresponding to the activity group with at least one parameter. Based on the workload, the power optimization system is configured to obtain a power consumption value corresponding to the workload of the region. In exemplary embodiments, the power optimization system is configured to identify the at least one parameter corresponding to the power consumption value. The power optimization system is configured to modify the at least one parameter to provide at least one modified parameter. Based on the modified parameter, the power optimization system is configured to initialize the workload corresponding to the activity group with the at least one modified parameter via the processor. Based on the workload with the at least one modified parameter, the power optimization system is configured to include obtaining a modified power consumption value corresponding to the workload of the region with the at least one modified parameter. Based on the modified power consumption value and the power consumption value, the power optimization system is configured to analyze the modified power consumption value and the power consumption value and determining the power sensitivity characteristic of the region of the device.

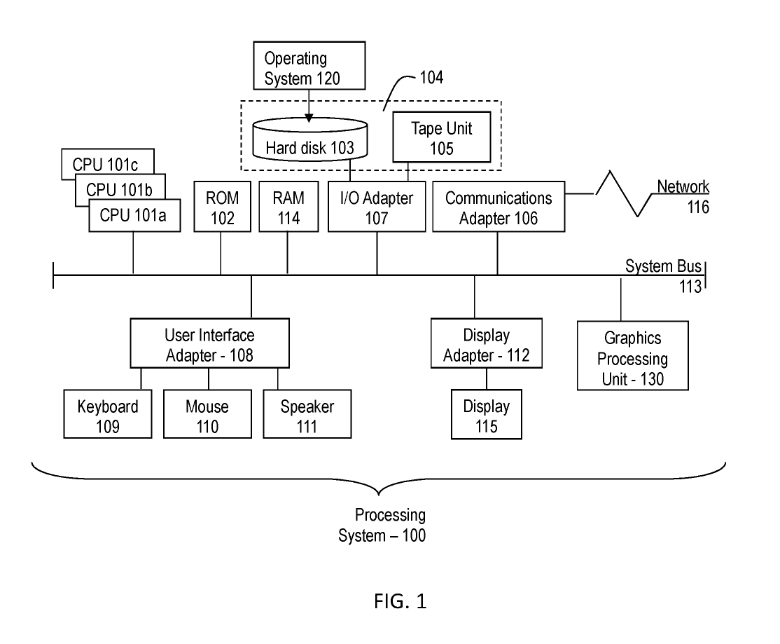

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

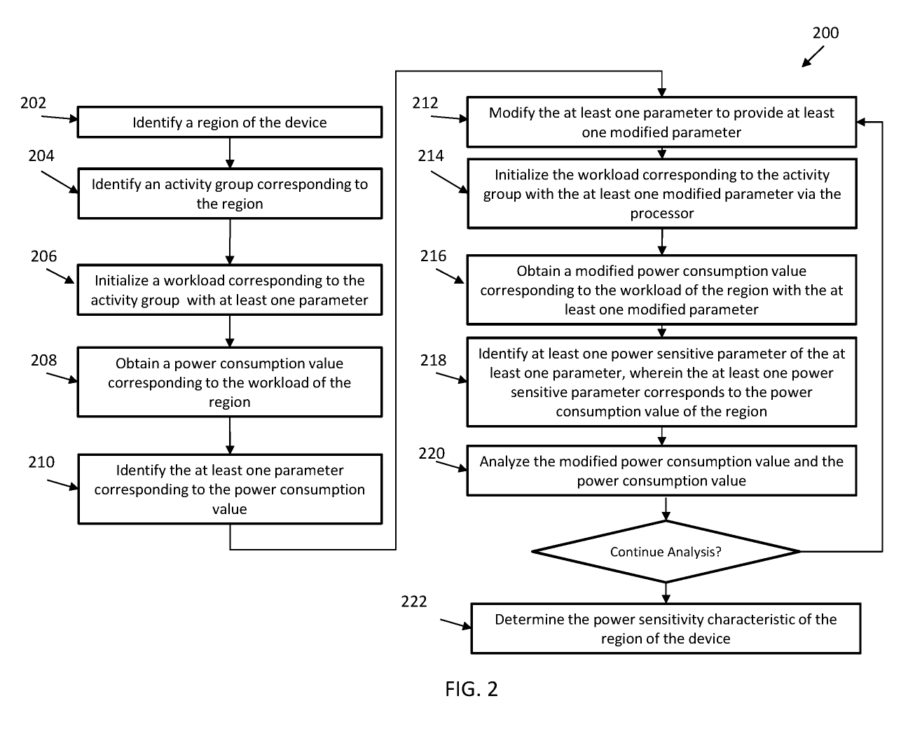

Referring now to FIG. 2, a flow diagram of a method 200 for providing a power optimized design for a device in accordance with an exemplary embodiment is shown. In an exemplary embodiment, the device can be any suitable electronic device, such as consumer devices, portable devices, etc. In certain embodiments, the device can be represented as a design or other suitable abstraction. As shown at block 202, a region of the device is identified. In an exemplary embodiment, regions can include a collection of gates and nets in a netlist, a physical region within which there are gates and nets, Hardware Description Language code in a Register-Transfer Level Abstraction of the design of the region, latch bounded partitions, clock gating domains, user defined regions, etc. In an exemplary embodiment, various regions of the device can perform various tasks or provide various functions. In certain embodiments, various regions can have different power consumption characteristics, requiring different optimization methods for optimizing the power consumption characteristics of a specific region. In certain embodiments, the spatial power profile of a region or a plurality of regions may indicate where power optimizations can be performed. In certain embodiments, regions of a device may appear to be equivalent with respect to power consumption without performing further analysis. Advantageously, the method described herein can identify such regions of a device that may appear equivalent with respect to power consumption.

As shown at block 204, an activity group corresponding to the region is identified via the processor. In an exemplary embodiment, a symbolic analysis of the region's logic can be performed to identify activity groups associated with the region. For example, activity groups can include primary inputs, latch outputs, primary outputs, embedded IP outputs, etc. In certain embodiments, certain logic functions of a region can be deemed as critical by the symbolic analysis. In certain embodiments, sub-regions of the region can be identified as well as activity values to corresponding to the initialization values of the sub-regions.

As shown at block 206, a workload corresponding to the activity group is initialized with at least one parameter via the processor. In an exemplary embodiment, the workload corresponding to the activity group can be a generalized activity assertion to serve as an abstraction or a vector for workloads the region or activity group may experience. In certain embodiments, a processor can perform a symbolic analysis of the region's logic to identify parameters of interest corresponding to the region. For example, the symbolic analysis can identify certain logic functions as critical. Further, symbolic analysis techniques can be utilized to prune relevant parameters, by performing path sensitization checks between internal points within a design and primary outputs to disregard parameters wherein a logical path does not exist.

As shown at block 208, a power consumption value corresponding to the workload of the region is obtained. In certain embodiments, the power consumption value can be measured, simulated, or approximated. In an exemplary embodiment, the power consumption of a region is a function of the activity within the region in response to the provided parameters. Therefore, in an exemplary embodiment, the power consumption of a region with a first set of parameters is observed. As shown at block 210, the at least one parameter corresponding to the power consumption value is identified.

As shown at block 212, the at least one parameter is modified to provide at least one modified parameter. In an exemplary embodiment, parameters corresponding to activity within the region are modified or selected. In certain embodiments, the parameters corresponding to the activity within the region are randomly modified or selected to reduce execution time. In other embodiments, parameters corresponding to the activity within the region can be selected to converge or cover a desired range. Parameter values can be selected within accepted or known ranges to allow the region to operate as desired.

As shown at block 214, the workload corresponding to the activity group is initialized with the at least one modified parameter via the processor. In an exemplary embodiment, modified parameters can be utilized to simulate or otherwise execute activities within the region with varying operating conditions simulating various uses. In certain embodiments, the modified parameters utilized may not simulate operating conditions but may be an abstraction of operating conditions for testing purposes.

As shown at block 216, a modified power consumption value corresponding to the workload of the region with the at least one modified parameter is obtained. Advantageously, by utilizing at least one modified parameter, impacts of the modified parameters to the power consumption value of the region can be ascertained and observed. As shown at block 218, at least one power sensitive parameter is identified, wherein the at least one power sensitive parameter corresponds to the power consumption value of the region. In an exemplary embodiment, power sensitive parameters can be identified by observing the change in power consumption for a change in a parameter value or type of parameter. A parameter may be considered a power sensitive parameter if a strong relationship is observed between the value of the parameter and the power consumption of the region. In certain embodiments, the relationship can be linear, exponential, etc. In certain embodiments, the power sensitive parameters can be used to characterize regions of the device.

As shown at block 220, the modified power consumption value and the power consumption value are analyzed. In an exemplary embodiment, power consumption values across various parameters can be compared and analyzed to determine relevant parameters. At block 220, a user or a criterion can determine to further iterate the analysis process. In an exemplary embodiment, parameters can be continued to be modified as described in block 212 to continue modifying parameters and determining resulting power consumption values to identify power sensitive parameters and identify regions as targets for further optimization.

As shown at block 222, the power sensitivity characteristic of the region is determined after sufficient or satisfactory analysis has been completed. In certain embodiments, analysis of the region may be completed after a desired number of cycles, converging solutions, etc. In an exemplary embodiment, the power sensitivity characteristic can be utilized to determine if the region is a critical or target region for power optimization by a designer.

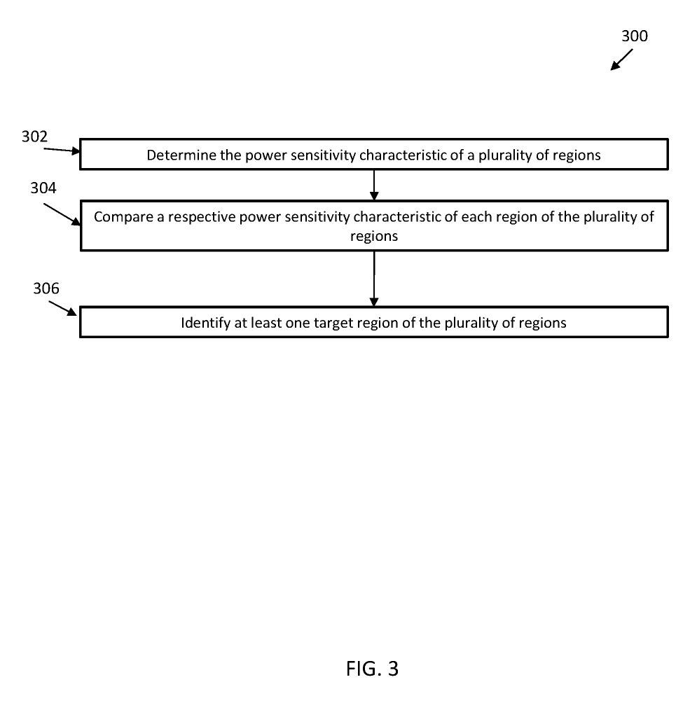

Referring to FIG. 3 a flow diagram of a method 300 for providing a power optimized design for a device in accordance with an exemplary embodiment is shown. In particular, method 300 illustrates analyzing a plurality of regions of a device to identify target regions for power consumption optimization. As shown at block 302, the power sensitivity characteristic of a plurality of regions is determined. In an exemplary embodiment, the method 200 described in FIG. 2 can be utilized to determine the power sensitivity characteristic of each region of the plurality of regions.

As shown at block 304, each of the respective power sensitivity characteristics of each of the plurality of regions is compared. In an exemplary embodiment, the power sensitivity characteristics can be compared using any suitable comparison method to prioritize the regions as candidates for optimization. In certain embodiments, comparisons can be performed by capturing activity parameters of the region in relative or comparative terms across multiple regions. In certain embodiments, region power consumption for nominal conditions can be considered. Further, the region's sensitivity to parameters can be considered.

In certain embodiments, the comparison of regions can be formulated as a justification problem, to be solved with satisfiability solving methods to reveal valuations of power sensitive parameters to identify regions to be selected for power optimization. Valuations can include values such as variation of power consumption in response to power sensitive parameters. The solving process can be iterative and can converge on one or more regions. In an exemplary embodiment, spatially or characteristically related regions may be grouped together for optimization purposes.

As shown at block 306, at least one target region of the plurality of regions is identified after the comparison between regions. In an exemplary embodiment, the at least one target region can be selected or grouped together for power consumption optimizations. For example, if multiple regions are sensitive to a drive strength parameter, an optimization procedure may optimize regions that are sensitive to drive current variations before production. In another example, an analysis can determine the power sensitivity distribution of a set of regions, such as when the drive current of all low-power devices is weaker by 20% or any other suitable amount. Advantageously, the method described herein can identify regions suitable for optimization and present the relevant parameters to a designer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for providing a power optimized design for a device, the method comprising:
identifying a region of the device;
identifying an activity group corresponding to the region;
initializing a workload corresponding to the activity group with at least one parameter;
obtaining a power consumption value corresponding to the workload of the region;
identifying at least one parameter corresponding to the power consumption value;
modifying the at least one parameter to provide at least one modified parameter;
initializing the workload corresponding to the activity group with the at least one modified parameter via a processor;
obtaining a modified power consumption value corresponding to the workload of the region with the at least one modified parameter;
analyzing the modified power consumption value and the power consumption value; and
determining a power sensitivity characteristic of the region of the device.

2. The computer-implemented method of claim 1, further comprising identifying at least one power sensitive parameter of the at least one parameter, wherein the at least one power sensitive parameter corresponds to the power consumption value of the region.

3. The computer-implemented method of claim 1, wherein the at least one modified parameter is randomly modified.

4. The computer-implemented method of claim 1, further comprising determining the power sensitivity characteristic of a plurality of regions.

5. The computer-implemented method of claim 4, further comprising comparing a respective power sensitivity characteristic of each region of the plurality of regions.

6. The computer-implemented method of claim 5, further comprising identifying at least one target region of the plurality of regions.

7. The computer-implemented method of claim 5, wherein comparing the respective power sensitivity characteristic of each region of the plurality of regions includes a satisfiability solver.

8. A computer program product for providing a power optimized design for a device, the computer program product comprising:
a non-transitory storage medium readable by a processing circuit and storing instructions for execution by the processing circuit for performing a method comprising:
identifying a region of the device;
identifying an activity group corresponding to the region;
initializing a workload corresponding to the activity group with at least one parameter;
obtaining a power consumption value corresponding to the workload of the region;
identifying the at least one parameter corresponding to the power consumption value;
modifying the at least one parameter to provide at least one modified parameter;
initializing the workload corresponding to the activity group with the at least one modified parameter via the processing circuit;
obtaining a modified power consumption value corresponding to the workload of the region with the at least one modified parameter;
analyzing the modified power consumption value and the power consumption value; and
determining a power sensitivity characteristic of the region of the device.

9. The computer program product of claim 8, the method further comprising identifying at least one power sensitive parameter of the at least one parameter, wherein the at least one power sensitive parameter corresponds to the power consumption value of the region.

10. The computer program product of claim 8, wherein the at least one modified parameter is randomly modified.

11. The computer program product of claim 8, the method further comprising determining the power sensitivity characteristic of a plurality of regions.

12. The computer program product of claim 11, the method further comprising comparing a respective power sensitivity characteristic of each region of the plurality of regions.

13. The computer program product of claim 12, the method further comprising identifying at least one target region of the plurality of regions.

14. The computer program product of claim 12, wherein comparing the respective power sensitivity characteristic of each region of the plurality of regions includes a satisfiability solver.

15. A power optimization system for providing a power optimized design for a device, comprising:
a processor in communication with one or more types of memory, the processor configured to:
identify a region of the device;
identify an activity group corresponding to the region;
initialize a workload corresponding to the activity group with at least one parameter;
obtain a power consumption value corresponding to the workload of the region;
identify the at least one parameter corresponding to the power consumption value;
modify the at least one parameter to provide at least one modified parameter;
initialize the workload corresponding to the activity group with the at least one modified parameter via the processor;
obtain a modified power consumption value corresponding to the workload of the region with the at least one modified parameter;
analyze the modified power consumption value and the power consumption value; and
determine a power sensitivity characteristic of the region of the device.

16. The power optimization system of claim 15, wherein the processor is further configured to identify at least one power sensitive parameter of the at least one parameter, wherein the at least one power sensitive parameter corresponds to the power consumption value of the region.

17. The power optimization system of claim 15, wherein the at least one modified parameter is randomly modified.

18. The power optimization system of claim 15, wherein the processor is further configured to determine the power sensitivity characteristic of a plurality of regions.

19. The power optimization system of claim 18, wherein the processor is further configured to compare a respective power sensitivity characteristic of each region of the plurality of regions.

20. The power optimization system of claim 19, wherein the processor is further configured to identify at least one target region of the plurality of regions.
